(19) United States
(12) Patent Application Publication
(10) Pub. No.: US 2025/0005610 A1
(43) Pub. Date: Jan. 2, 2025

(54) METHODS FOR REDUCING LOCAL CONGESTION AND LOSS IN ELECTRIC POWER GRIDS AND DEVICES THEREOF

(71) Applicant: Sabreez PBC, Newburyport, MA (US)

(72) Inventor: W. Scott HOPPE, Newburyport, MA (US)

(21) Appl. No.: 18/655,429

(22) Filed: May 6, 2024

Related U.S. Application Data
(60) Provisional application No. 63/464,108, filed on May 4, 2023.

(51) Int. Cl. G06Q 30/0202; G06Q 30/0201

(52) U.S. Cl. CPC G06Q 30/0202; G06Q 30/0206

(57) ABSTRACT

The disclosed technology relates to methods, energy analysis computing devices, and non-transitory computer readable media for reducing local congestion and loss in electric power grids. In some examples, the technology obtains energy generation and wholesale price data from a balancing authority server. The energy generation data comprises wind generation, solar power generation, and thermal power resource data. A wind number value is generated, based on the wind generation and thermal power resource data, a solar boost value is generated, based on the solar power generation and thermal power resource data, and a regional clean energy factor value is generated based on the wind number and solar boost values. A local clean energy factor value is generated based on the regional clean energy factor value and the wholesale price data. A notification is sent to a user device when the local clean energy factor exceeds a threshold.

This application claims priority to U.S. Provisional Patent Application Ser. No. 63/464, 108, filed May 4, 2023, which is hereby incorporated herein by reference in its entirety.

### FIELD

This technology generally relates to energy analysis and optimized energy utilization and, more particularly, to methods and devices for reducing local congestion and loss in electric power grids.

### BACKGROUND

Energy expenses can be reduced by consuming energy when wind power and solar power are abundant relative to electric power generated from thermal resources, such as fossil-fuel burning power plants. U.S. Pat. No. 9,851,701, entitled “METHODS FOR OPTIMIZING AN ANALYSIS OF ENERGY CONSUMPTION TO REDUCE COST AND DEVICES THEREOF,” which is incorporated herein by reference in its entirety, disclosed a wind number variable useful by consumers to reduce costs by using electricity when wind power is elevated. A similar method of analysis applied to solar power generation, yielding another variable (i.e., a solar boost variable) to facilitate management of energy consumption when solar power is elevated, has also been developed.

Electricity markets with abundant wind and solar power experience wholesale market price fluctuations based on the availability of wind power, solar power and consumer demand. In many electric power markets, daily consumer demand has been balanced by fossil-fuel burning plants; as demand rises each day, fossil fuel burning plants come online and as demand peaks and then decreases, the fossil-fuel burning plants turn off. This leads to increased costs as power plants ramp up, and lower costs for electric power after peak demand has been met.

This peak demand can also be met by other energy resources, such as hydro-electric-power generation, and more recently through battery-storage that discharges stored electric power, but also through demand reduction based on generation data. To balance daily and year-round electric-power supply with demand, it is desirable to reduce yearly peak demand and daily peak demand while minimizing costs to consumers, but of primary importance is to provide electric power reliably every minute of the year to every end user.

The costs to operate a power plant include capital investment, operations, maintenance, and fuel. Other costs include emissions that are paid for directly through a regulatory system in the case of California and other states participating in the Regional Greenhouse Gas Initiative, or increasingly as non-regulated expenses accounted for by private businesses. But electric power generation is only a portion of the cost to provide electric power to end users.

Another cost of providing electric power consumption is transmission and distribution, which is expressed through wholesale pricing as losses and congestion pricing, among other compensation systems. Within a power system, congestion and loss pricing varies throughout the day at specific locations and regionally. Information systems and electric-power controls are now available that can switch electric-power loads according to electronic signals, such as time-variable retail prices. Retail electric-power prices in turn reflect in part wholesale market prices, which may include wholesale energy costs, congestion and losses to the distribution system, and emissions costs among other costs. Emissions have started to be used as one of the methods of describing electric power and switching loads on and off, but other system costs, particularly congestion, can be substantial enough to make emission concerns secondary to other costs. In some cases of congestion and losses, switching electric-power consuming devices using a regional emissions signal may even increase emissions and costs.

Attempting to describe congestion and losses as local emissions is problematic; the extent that electric-power consumption can allocate emissions to a discrete location and time is debatable and in a market in which emissions are already paid for, as it is in several U.S. states, reporting emissions only captures a portion of price. Thus, current energy analytics systems are inaccurate and unable to facilitate effective load switching and optimized utilization of energy originating from clean energy sources.

### BRIEF DESCRIPTION OF THE DRAWINGS

The disclosed technology is illustrated by way of example and not limitation in the accompanying figures, in which like references indicate similar elements.

FIG. 1 is a block diagram of an exemplary network environment that includes an energy analysis computing device.

FIG. 2 is a block diagram of an exemplary energy analysis computing device.

FIG. 3 is a flow diagram of a method for real-time voice enhancement.

FIGS. 4A-C illustrate a table and corresponding graph showing correlations of clean energy factors (CEFs) and locational marginal price (LMP).

### DETAILED DESCRIPTION

The clean energy factor described and illustrated herein can be used to represent locational variations in congestion and losses since it is a defined variable independent of emissions, and therefore more accurately describes congestion and losses, as well as electric power generation. The wind number value and solar boost value described and illustrated herein collectively yield a regional clean energy factor, which is inversely correlated with wholesale prices and emissions for controlling energy use.

An energy analysis computing device 102 also is disclosed herein that advantageously reduces local energy costs based on wholesale locational marginal prices (LMPs) and the clean energy factor. Connected electric power consuming devices that process information to switch electric power loads based on energy analysis computing device 102 output can reduce energy costs and can also reduce the need to invest in distribution systems by controlling electric power loads. Moreover, the clean energy factor makes energy management easy to understand, facilitating manual control and scheduling.

The clean energy factor of this technology describes an electric power system with abundant solar and wind power resources in an easy to understand format that can be used by the energy analysis computing device 102 to manage energy consumption and can also be easily understood by energy users wishing to use cleaner energy to reduce their costs as well costs to the system as a whole, including fuel costs, emissions, transmission, and distribution, and other costs of providing electric power to end users. A method for modifying and using the clean energy factor to manage local energy use based on wholesale locational price data and other data is also disclosed herein. The clean energy factor enables programs that provide cost savings to energy consumers to reduce, delay, or even replace and/or upgrade to local electric power distribution systems.

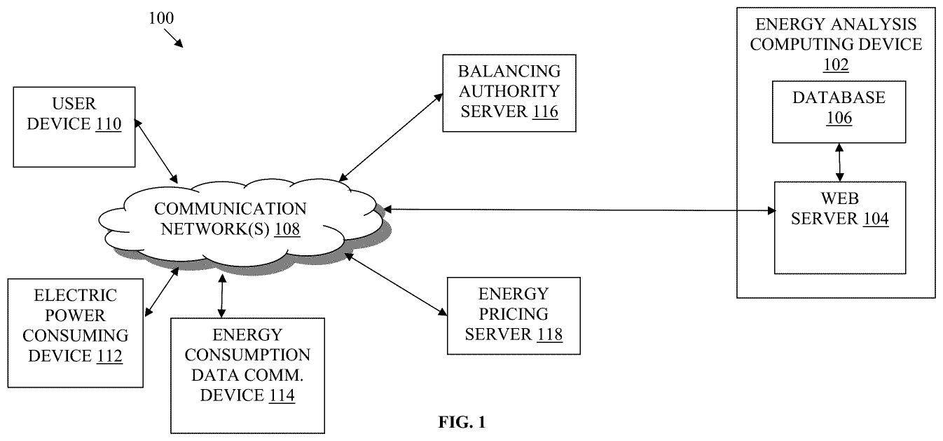

Referring now to FIG. 1, an exemplary network environment 100 is illustrated that includes an energy analysis computing device 102, with a web server 104 coupled to a backend database 106, which is coupled via communication network(s) 108 to a user device 110, an electric power consuming device 112, an energy consumption data communication device 114, a balancing authority server 116, and an energy pricing server 118. The network environment 100 may include other network devices such as one or more routers or switches, for example, which are known in the art and thus will not be described herein.

In this example, the energy analysis computing device 102, web server 104 database 106, user device 110, electric power consuming device 112, energy consumption data communication device 114, balancing authority server 116, and energy pricing server 118 are disclosed in FIG. 1 as dedicated hardware devices. However, one or more of those devices can also be implemented in software within one or more other devices in the network environment 100. As one example, the energy analysis computing device 102, as well as any of its components or applications, can be implemented as software executing on the balancing authority server 116 or the energy pricing server 118, and many other permutations and types of implementations and network topologies can also be used in other examples.

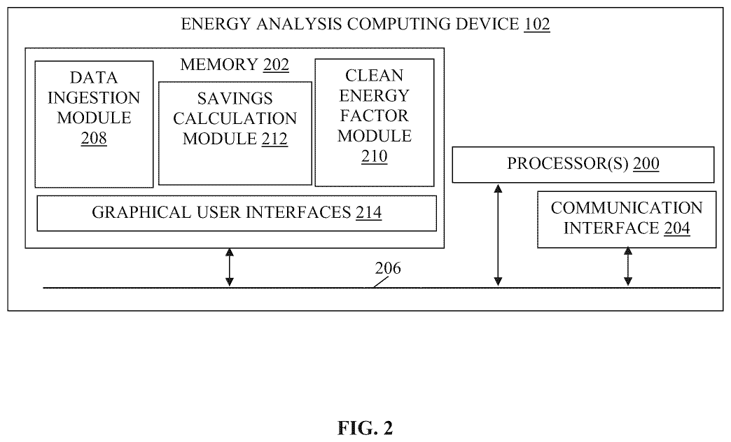

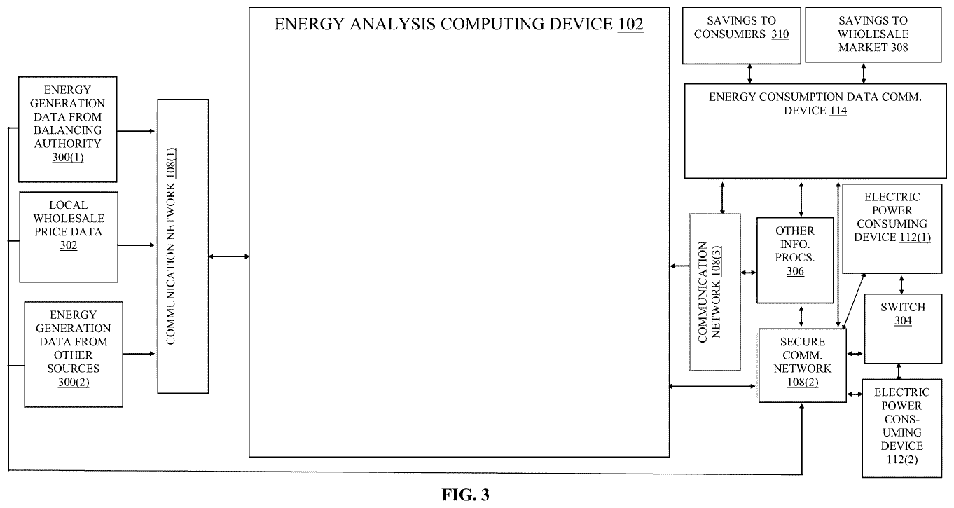

Referring to FIGS. 1-2, the energy analysis computing device 102 may perform any number of functions, including providing user interfaces to the user device 110, obtaining historical and current energy utilization and pricing data over the communication network(s) via application programming interfaces (APIs), and communicating with the electric power consuming device 112 and/or switches or other devices coupled thereto, to control operation and associated energy utilization, for example. The energy analysis computing device 102 (e.g., the web server 104) in this example includes processor(s) 200, memory 202, and a communication interface 204, which are coupled together by a bus 206, although the energy analysis computing device 102 can include other types or numbers of elements in other configurations.

The processor(s) 200 of the energy analysis computing device 102 may execute programmed instructions stored in the memory 202 of the energy analysis computing device 102 for any number of the functions described and illustrated herein. The processor(s) 200 may include one or more processing cores, one or more central processing units (CPUs), and/or one or more graphics processing units (GPUs), for example, although other types of processor(s) can also be used.

The memory 202 stores these programmed instructions for one or more aspects of this technology as described and illustrated herein, although some or all the programmed instructions could be stored elsewhere. A variety of different types of storage devices, such as random-access memory (RAM), read only memory (ROM), hard disk, solid state drives, flash memory, or other computer readable medium which is read from and written to by a magnetic, optical, or other reading and writing system that is coupled to the processor(s), can be used for the memory 202.

Accordingly, the memory 202 can store applications that can include computer or machine executable instructions that, when executed by the processor(s) 200, cause the energy analysis computing device 102 to perform actions, such as to transmit, receive, or otherwise process network messages and requests, for example, and to perform other actions described and illustrated below. The application(s) can be implemented as components of other applications, operating system extensions, and/or plugins, for example.

Further, the application(s) may be operative in a cloud-based computing environment with access provided via a software-as-a-service (SaaS) model using the communication network(s) 108. The application(s) can be executed within or as virtual machine(s) or virtual server(s) that may be managed in a cloud-based computing environment. Also, the application(s), and even the energy analysis computing device 102 itself, may be in virtual server(s) running in a cloud-based computing environment rather than being tied to specific physical network computing devices. Also, the application(s) may be running in virtual machines (VMs) executing on the outcome prediction system and managed by a hypervisor.

In this example, the memory 202 includes a data ingestion module 208, a clean energy factor module 210, a savings calculation module 212, and graphical user interfaces (GUIs) 214. The data ingestion module 208 in this example is configured to obtain energy generation data from the balancing authority server 116, local wholesale price data from the energy pricing server 118, and energy consumption data (e.g., energy consumed by the electric power consuming device 112) from the energy consumption data communication device 114 via the communication network(s) 108.

Optionally, the data ingestion module 208 can perform extract, transform, and load (ETL) processes, data cleansing, and other operations on the obtained data. The data ingestion module 208 can utilize APIs of the balancing authority server 116, energy pricing server 118, and/or energy consumption data communication device 114, for example, and can store the obtained data in the database 106 of the energy analysis computing device 102, which can be a relational database (e.g., a structured query language (SQL) database), although other types of databases can also be used in other examples.

With the ingested data, the clean energy factor module 210 is configured to generate clean energy factor values, wind number values, and solar boost values, for example, which can be used by the energy analysis computing device 102 to control energy utilization at the electric power consuming device 112 and/or report to the user device 110 regarding opportunities to use clean energy and thereby reduce energy utilization cost. The GUIs 214 can be provided to the user device 110 as part of a web application, for example, to report output of the savings calculation module 212, such as savings opportunities or actual savings as a result of changed electric power consumption behavior.

The communication interface 204 of the energy analysis computing device 102 operatively couples and communicates between the energy analysis computing device 102, user device 110, electric power consuming device 112, energy consumption data communication device 114, balancing authority server 116, and/or energy pricing server 118, which are coupled together at least in part by the communication network(s) in this example, although systems with other types or number of connections or configurations to other devices or elements can also be used. The communication network(s) 108 can include wide area network(s) (WAN(s)) and/or local area network(s) (LAN(s)), for example, and can use TCP/IP over Ethernet, although other types or numbers of protocols or communication networks can be used. The communication network(s) 108 can employ any suitable interface mechanisms and network communication technologies including, for example, Ethernet-based Packet Data Networks (PDNs).

The energy analysis computing device 102 in some examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the energy analysis computing device 102. Additionally, one or more of the devices that together comprise the energy analysis computing device 102 in other examples can be standalone devices or integrated with one or more other devices or apparatuses.

Each of the balancing authority server 116 and energy pricing server 118 can be servers or other devices that include a processor, memory, and a communication interface, which are coupled together by a bus or other communication link (not illustrated), although other numbers or types of components could also be used. The balancing authority server 116 can be hosted by an entity responsible for regional electric grid balancing, for example, and can be configured to receive, store, and provide to the energy analysis computing device 102 energy generation data (e.g., the proportional source (e.g., fossil fuels, wind, or solar) of the energy generated over time). The energy pricing server 118 can be configured to receive, store, and provide to the energy analysis computing device 102 local wholesale price data for energy. The energy generation data and/or wholesale price data can be provided to the energy analysis computing device 102 upon request via an API, for example.

The user device 110 of the network environment 100 in this example includes any type of computing device that can exchange network data, such as mobile, desktop, laptop, or tablet computing devices, virtual machines (including cloud-based computers), or the like. The user device 110 in this example includes a processor, memory, and a communication interface, which are coupled together by a bus or other communication link (not illustrated), although other numbers or types of components could also be used. The user device 110 may run services and/or interface applications, such as standard web browsers or the standalone applications, which may provide an interface to communicate with the energy analysis computing device 102 via the communication network(s). The user device 110 may further include a display device, such as a display screen or touchscreen, or an input device, such as a keyboard or mouse, for example (not shown).

The electric power consuming device 112 and/or the energy consumption data communication device 114 can be collocated with the user device 110 and/or associated with a same user or property, for example. The electric power consuming device 112 can be any device capable of using electric power (e.g., a residential electric vehicle charging device). The energy consumption data communication device 114 can be any type of device (e.g., smart energy meter) configured to report the energy consumption at the property associated with the use of the user device 110 and including the electric power consuming device 112, for example.

Although the exemplary network environment 100 with the energy analysis computing device 102, user device 110, electric power consuming device 112, energy consumption data communication device 114, balancing authority server 116, energy pricing server 118, and communication network(s) 108 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the energy analysis computing device 102, user device 110, electric power consuming device 112, energy consumption data communication device 114, balancing authority server 116, and/or energy pricing server 118, for example, may be configured to operate as virtual instances on the same physical machine. In other words, one or more of the energy analysis computing device 102, user device 110, electric power consuming device 112, energy consumption data communication device 114, balancing authority server 116, and/or energy pricing server 118 may operate on the same physical device rather than as separate devices communicating through the communication network(s). Additionally, there may be more or fewer energy analysis computing devices, user devices, electric power consuming devices, energy consumption data communication devices, balancing authority servers, and/or energy pricing servers than illustrated in FIG. 1.

The examples of this technology may also be embodied as one or more non-transitory computer readable media having instructions stored thereon, such as in the memory 202, for one or more aspects of the present technology, as described and illustrated by way of the examples herein. The instructions in some examples include executable code that, when executed by one or more processors, such as the processor(s) 200, cause the processors to carry out steps necessary to implement the methods of the examples of this technology that will now be described and illustrated herein.

Referring to FIG. 3, a flow diagram of an exemplary method for reducing local congestion and loss in electric power grids is illustrated. In this example, the energy analysis computing device 102 obtains, via a first communication network 108(1) (e.g., one or more local or wide area networks) or alternatively a second communication network 108(2) (e.g., a secure network), energy generation data 300(1) from a regional balancing authority server 116, and/or energy generation data 300(2) from other source(s), for one or more wind power resources, solar power resources, and/or thermal power resources, for example.

The energy analysis computing device 102 then retrieves wholesale price data 302 through the first communication network 108(1) and/or the second communication network 108(2) from a regional balancing authority server (e.g., via the energy pricing server 118) to obtain wholesale energy price, congestion, and loss data at five minute intervals, hourly intervals, or other intervals and/or at other times. Alternatively, energy generation data 300 and/or wholesale price data 302 may be obtained by the energy analysis computing device 102 through the first and/or second communication networks 108(1)-(2) from an alternate source, such as a third-party energy data provider.

The energy analysis computing device 102 then calculates a wind number value, such as described in U.S. Pat. No. 9,851,701 for example. Wind generation data is divided by thermal power resource data in the energy generation data 300, then optionally multiplied by a constant, to produce a whole number in some examples. The energy analysis computing device 102 then calculates a solar boost value by dividing solar power generation data by thermal power resource data in the energy generation data 300, then optionally multiplying the result by a constant, which can be the same or a different constant, to produce a whole number. The wind number value and solar boost values are added together to produce a regional clean energy factor value, optionally using historical data, real-time data, and/or available forecast data.

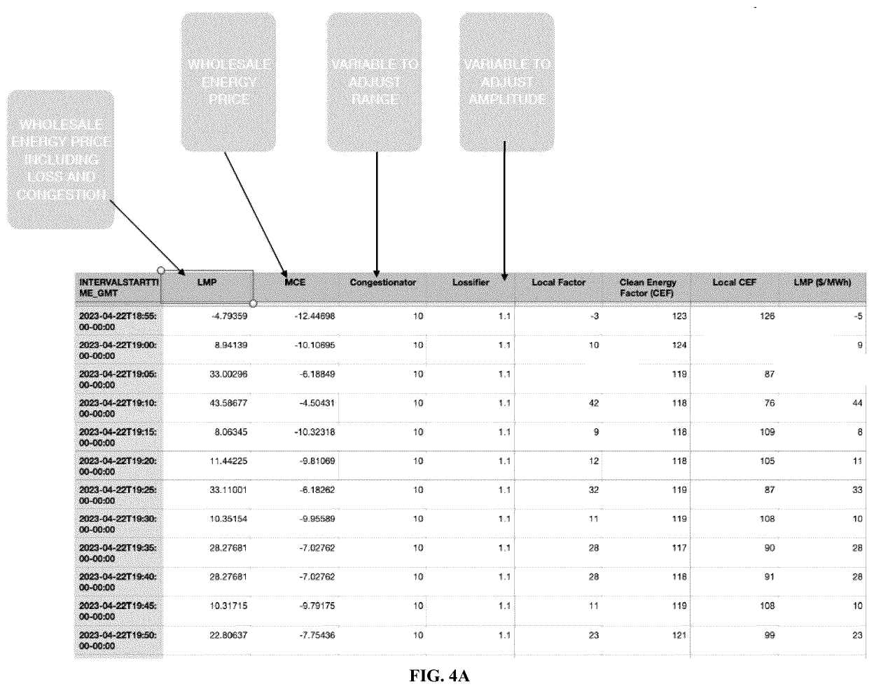

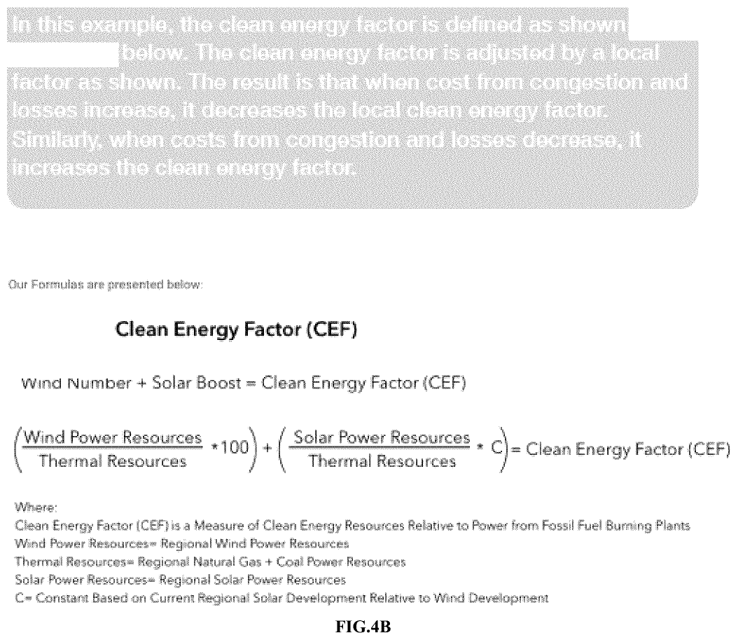

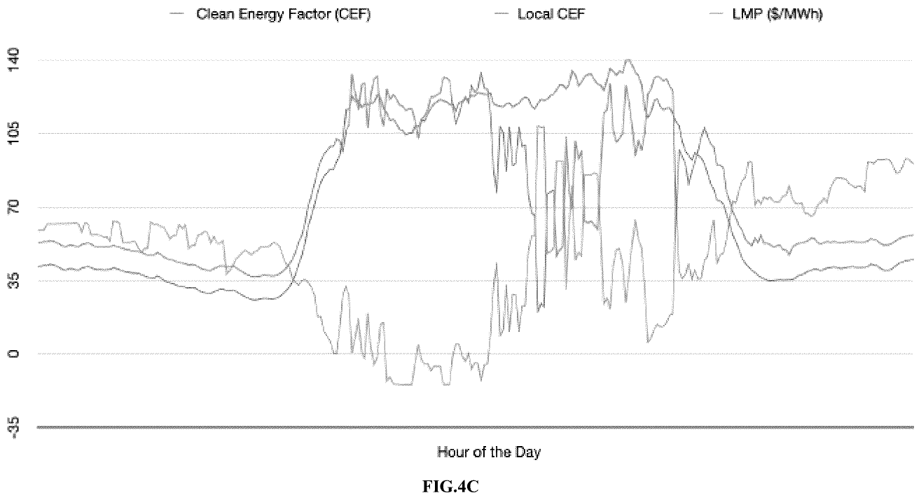

The energy analysis computing device 102 then calculates a local clean energy factor value based on wholesale congestion and losses in the local wholesale price data 302, for example, to modify the regional clean energy factor value by setting a range and amplitude of values over a time period using historical data, real-time data, and/or available forecast data, as described and illustrated with reference to FIGS. 4A-C. In particular, as illustrated in FIG. 4B, the regional clean energy factor is adjusted by the local clean energy factor value. The result is that, as illustrated in FIG. 4C, when cost from congestion and losses increase, the local clean energy factor value decreases. Conversely, when cost from congestion and losses decrease, the local clean energy factor value increases.

Optionally, the database 106 retains one or more of the energy generation data 300, local wholesale price data 302, wind number values, solar boost values, regional clean energy factor value, and/or local clean energy factor value in some examples. The local clean energy factor value calculation is applied in real time to inform an energy user (e.g., via the user device 110) that electric power is cleaner and/or costs less and to switch a device (e.g., the electric power consuming device 112) on when the local clean energy factor value is high and to turn off a device (e.g., the electric power consuming device 112) when the clean energy factor is low. The communication can be via Short Message Service (SMS) or any other type of notification communication via the communication network(s) 108.

The local clean energy factor value is applied to energy resource forecast data to inform a user of opportunities to use cleaner energy or program a device (e.g., the electric power consuming device 112) to operate during periods when the local clean energy factor value is elevated several days in advance to avoid periods of high cost energy use and potential critical peak prices. The energy resource forecast data can be generated based on historical stored energy generation data 300 and/or local wholesale price data 302, for example. The local clean energy factor value can be applied to energy consumption data over any historical period of time to report the effectiveness of energy usage in reducing costs.

In other examples, with this technology, the electric power consuming device 112 can be turned on when the local clean energy factor value is elevated (e.g., based on a predetermined threshold local clean energy factor value) and turn off when the local clean energy factor value is low. As an example, the energy source and usage computing device 102 outputs the local clean energy factor value via a secure communication network 108(2) to an electronically actuated switch 304, which can control the charging of an electric vehicle, switching the vehicle charging (i.e., the electric power consuming device 112) off during a price spike in the short term, and/or switching the vehicle charging on during a price drop as the local clean energy factor value is rising. The operation of the switch 304 can be based on a comparison of the local clean energy factor value to a stored threshold such that the switch 304 automatically turns the electric consuming device 112 on and/or off based on the local clean energy factor value.

Another example, a battery can be switched to charge during periods when the local clean energy factor value is high and then discharge stored electricity to devices during periods of elevated electric prices to reduce energy costs. Other examples of switching may be applied to electric-power consuming devices 112(1)-(2), such as thermostats controlling a heating, ventilation and air-conditioning (HVAC) system, dishwashers, clothes washers, clothes dryers, other appliances, water pumps servicing a swimming pool, other pumps, and other discretionary electric-power consuming devices that generally run for more than one hour and can switch on based on the forecast local clean energy factor value.

One or more of the electric-power-consuming devices 112(1)-112(n) sends energy consumption data through a secure communication network 108(2) to an energy consumption data communication device 114 in some examples. Alternatively, one or more of the electric power consuming devices 112(1)-(2) send energy consumption data through a communication network 108(3) or a secure communication network 108(2) to the energy analysis computing device 102. The energy consumption data communication device 114 sends energy consumption data through a secure communication network 108(2) to the energy analysis computing device 102.

In another example, the energy analysis computing device 102 outputs data from the database device 106 through the communication network 108(3) to other information processes 306, which can inform users (e.g., via the user device 110) of the electric consuming device 112, resulting in the electric power consuming device 312 sending energy consumption data through the communication network 108(3) or the secure communication network 108(2) to the energy consumption data communication device 114. Energy usage data returned from the electric power consuming device 112, or from the energy consumption data communication device 114 through the communication network 108(3) or the secure communication network 108(2) is processed by the energy analysis computing device 102 and recorded by the database 106 in the energy source energy analysis computing device 102.

The method disclosed in U.S. Pat. No. 9,851,701, in addition to the method disclosed herein, is applied to the stored data to generate saved money in the wholesale market 308 and/or savings provided to consumer(s) 310. In each case above, the local clean energy factor value controls energy consumption, which results in savings to consumers, to the wholesale market operator by reducing demand when the local clean energy factor value is low and increasing demand when the local clean energy factor value is high. The reward or other compensation to energy consumers for reducing their energy demand may take alternate forms, such as monetary compensation, if users find value in using cleaner energy and sharing their use of cleaner energy with their peers. Reducing, delaying, or even replacing the need to upgrade electric power distribution systems through the reduction of electric power demand during periods of elevated congestion and losses is another advantage of the disclosed technology.

Having thus described the basic concept of the invention, it will be rather apparent to those skilled in the art that the foregoing detailed disclosure is intended to be presented by way of example only and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. An energy analysis computing device, comprising memory having instructions stored thereon and one or more processors coupled to the memory and configured to execute the instructions to:
obtain energy generation data and wholesale price data from one or more of a balancing authority server or an energy pricing server and via one or more communication networks, wherein the energy generation data comprises wind generation data, solar power generation data, and thermal power resource data;
generate a wind number value, based on the wind generation data and the thermal power resource data, a solar boost value, based on the solar power generation data and the thermal power resource data, and a regional clean energy factor value based at least in part on the wind number value and the solar boost value;
generate a local clean energy factor value based on the regional clean energy factor value and at least a portion of the wholesale price data; and
send a notification comprising the local clean energy factor value to a user device via the communication networks when the local clean energy factor value exceeds a first threshold value to facilitate one or more of increased clean energy utilization or decreased energy cost to a user of the user device with respect to energy consuming devices associated with the user.

2. The energy analysis computing device of claim 1, wherein the one or more processors are further configured to execute the instructions to send the local clean energy factor value to a switch via the communication networks to facilitate automatic electrical actuation of at least one of the energy consuming devices coupled to the switch based on a comparison of the local clean energy factor value to a second threshold value.

3. The energy analysis computing device of claim 1, wherein the regional clean energy factor value is a measure of electrical power generated from clean energy resources relative to other electrical power generated from fossil fuels.

4. The energy analysis computing device of claim 1, wherein the portion of the wholesale price data comprises a wholesale energy price including loss and congestion and corresponds to a locational marginal price.

5. The energy analysis computing device of claim 1, wherein the one or more processors are further configured to execute the instructions to:
obtain energy consumption data via the communication networks and an energy consumption data communication device coupled to the energy consuming device; and
determine a cost savings over a historical time period based on the wholesale price data and the energy consumption data.

6. The energy analysis computing device of claim 1, wherein the energy generation data comprises real-time energy resource data and one or more processors are further configured to execute the instructions to generate the regional clean energy factor further based on one or more of historical energy generation data, the real-time energy resource data, or energy resource forecast data.

7. A method for reducing local congestion and loss in electric power grids, the method implemented by an energy analysis computing device and comprising:
obtaining energy generation data and wholesale price data from one or more of a balancing authority server or an energy pricing server and via one or more communication networks, wherein the energy generation data comprises wind generation data, solar power generation data, and thermal power resource data;
generating a wind number value, based on the wind generation data and the thermal power resource data, a solar boost value, based on the solar power generation data and the thermal power resource data, and a regional clean energy factor value based at least in part on the wind number value and the solar boost value;
generating a local clean energy factor value based on the regional clean energy factor value and at least a portion of the wholesale price data; and
sending a notification comprising the local clean energy factor value to a user device via the communication networks when the local clean energy factor value exceeds a first threshold value to facilitate one or more of increased clean energy utilization or decreased energy cost to a user of the user device with respect to energy consuming devices associated with the user.

8. The method of claim 7, further comprising sending the local clean energy factor value to a switch via the communication networks to facilitate automatic electrical actuation of at least one of the energy consuming devices coupled to the switch based on a comparison of the local clean energy factor value to a second threshold value.

9. The method of claim 7, wherein the regional clean energy factor value is a measure of electrical power generated from clean energy resources relative to other electrical power generated from fossil fuels.

10. The method of claim 7, wherein the portion of the wholesale price data comprises a wholesale energy price including loss and congestion and corresponds to a locational marginal price.

11. The method of claim 7, further comprising:
obtaining energy consumption data via the communication networks and an energy consumption data communication device coupled to the energy consuming device; and
determining a cost savings over a historical time period based on the wholesale price data and the energy consumption data.

12. The method of claim 7, wherein the energy generation data comprises real-time energy resource data and the method further comprises generating the regional clean energy factor further based on one or more of historical energy generation data, the real-time energy resource data, or energy resource forecast data.

13. A non-transitory computer-readable medium comprising instructions that, when executed by at least one processor, cause the at least one processor to:
obtain energy generation data and wholesale price data from one or more of a balancing authority server or an energy pricing server and via one or more communication networks, wherein the energy generation data comprises wind generation data, solar power generation data, and thermal power resource data;
generate a wind number value, based on the wind generation data and the thermal power resource data, a solar boost value, based on the solar power generation data and the thermal power resource data, and a regional clean energy factor value based at least in part on the wind number value and the solar boost value;
generate a local clean energy factor value based on the regional clean energy factor value and at least a portion of the wholesale price data; and
send a notification comprising the local clean energy factor value to a user device via the communication networks when the local clean energy factor value exceeds a first threshold value to facilitate one or more of increased clean energy utilization or decreased energy cost to a user of the user device with respect to energy consuming devices associated with the user.

14. The non-transitory computer-readable medium of claim 13, wherein the instructions, when executed by the at least one processor further causes the at least one processor to send the local clean energy factor value to a switch via the communication networks to facilitate automatic electrical actuation of at least one of the energy consuming devices coupled to the switch based on a comparison of the local clean energy factor value to a second threshold value.

15. The non-transitory computer-readable medium of claim 13, wherein the regional clean energy factor value is a measure of electrical power generated from clean energy resources relative to other electrical power generated from fossil fuels.

16. The non-transitory computer-readable medium of claim 13, wherein the portion of the wholesale price data comprises a wholesale energy price including loss and congestion and corresponds to a locational marginal price.

17. The non-transitory computer-readable medium of claim 13, wherein the instructions, when executed by the at least one processor further causes the at least one processor to obtain energy consumption data via the communication networks and an energy consumption data communication device coupled to the energy consuming device; and
determine a cost savings over a historical time period based on the wholesale price data and the energy consumption data.

18. The non-transitory computer-readable medium of claim 13, wherein the energy generation data comprises real-time energy resource data and the instructions, when executed by the at least one processor further causes the at least one processor to generate the regional clean energy factor further based on one or more of historical energy generation data, the real-time energy resource data, or energy resource forecast data.
